(19) United States
(12) Patent Application Publication
(10) Pub. No.: US 2021/0036876 A1
(43) Pub. Date: Feb. 4, 2021

(54) Power Supply Control Systems and Methods

(71) Applicant: Senao Networks, Inc., Taoyuan City (TW)

(72) Inventors: Pi-Kuang Ku, New Taipei City (TW); Po-Yueh Wu, Taoyuan (TW)

(21) Appl. No.: 16/718,208

(22) Filed: Dec. 18, 2019

(30) Foreign Application Priority Data
Jul. 31, 2019 (TW) 108127228

(51) Int. Cl. H04L 12/10; H02M 3/16; G06F 1/26

(52) U.S. Cl. CPC H04L 12/10; G06F 1/26; H02M 3/16

(57) ABSTRACT

Systems and methods for controlling a power supply system comprising two or more independent power supplies, in which a current flow circuit comprises a power adjustment module, a current amplification module, and a voltage adjustment module. The power adjustment module is used to adjust the power of the power supply load, the current amplification module is used to receive the PSE type indication signal sent by the network power supply interface, so as to determine the rated output power information of the corresponding power supply, and the voltage adjustment module adjusts the corresponding power output voltage and current according to the voltage signal corresponding to all the power supplies, and makes the ratio of output current between all the adjusted power supplies and the rated output power ratio between all the power supplies converge. Each power supply provides output power that meets their maximum power rating.

### RELATED APPLICATIONS

The present application claims the priority of Taiwan Patent Application No. 108127228, filed on Jul. 31, 2019, the disclosure of which is hereby incorporated by reference herein.

### FIELD OF THE INVENTION

The present invention relates to power supply control systems and methods that may be particularly suitable for use in systems requiring dynamic granular control of power output, such as Power over Ethernet systems.

### BACKGROUND OF THE INVENTION

A Power over Ethernet (PoE) system may comprise power sourcing equipment (PSE) and at least one powered device (PD) connected to one another via an Ethernet cable. The PSE is able to deliver power to the PD through the Ethernet cable such that the PD does not need to be plugged into wall power or another conventional power supply means. In PoE systems, the Ethernet cables typically also carry data, and so the cables can be used for conveying both data and power.

Under the IEEE 802.3bt PoE standard, a single PSE may be required to provide up to 71 W of power to a PD. This is a higher requirement than earlier PoE standards. For instance, IEEE 802.3at requires only 12.95 W of power to be available to a PD and IEEE 802.3af requires only 25.5 W.

A conventional way to achieve higher output power in a PSE is to simply use more power supplies in a PSE. However, when power supplies of different power outputs are arranged in parallel, as is conventional, the effective output power of each power supply becomes limited to the output of the lower output power supply. For example, where a power supply with an output power of 71 W is arranged together in parallel with a power supply with an output power of 25.5 W, the output power of each power supply is limited to 25.5 W, limiting the maximum overall output power to only 51 W. Therefore, there is a need for a system that can dynamically adjust to the different power requirements of the various types of PDs, including to provide the maximum amount of power under IEEE 802.3bt, while minimizing the amount of circuitry that would need to be added to existing PSE designs.

### SUMMARY OF THE INVENTION

The present invention provides systems and methods for controlling a power supply system using a dynamically adjusted current amplification ratio, so that parallel power supplies of different output power can each output its maximum rated power.

In order to achieve the foregoing, the power supply control system of the present invention comprises two or more current flow circuits, wherein each current flow circuit is connected to an independent power supply through a power supply interface, and the current flow circuits are connected to each other and connected to the same load. Each current flow circuit comprises a power adjustment module, a current amplification module, and a voltage adjustment module.

The power adjustment module is connected to a power supply interface to adjust the output power of the power supply. The current amplification module is connected to the power supply interface through the power adjustment module to receive a PSE type indication signal sent by the network power supply interface. The PSE type indication signal contains the rated output power information of the corresponding power supply. The current amplification module transmits a voltage adjustment signal based on the PSE type indication signal. The voltage adjustment module receives voltage adjustment signals from all current flow circuits, and accordingly adjusts the output voltage of the corresponding power supply. This allows the adjusted ratio of output current between the power supplies to be consistent with the ratio of output power between the power supplies.

In one embodiment, the power adjustment module may also compensate for line loss in power transmission.

In one embodiment, the current amplification module further comprises a power adjustment circuit, a current amplification circuit, and a voltage conversion circuit. The power adjustment circuit judges the rated output power of a power supply according to the corresponding PSE type indication signal, and to send the first voltage adjustment signal. The current amplification circuit determines the output current of the power supply according to the first voltage adjustment signal. The voltage conversion circuit is used to convert the amplified output current into the voltage adjustment signal.

In one embodiment, the PSE type indication signal comprises a first flag signal and a second flag signal which together indicate the rated output power information of the power supply.

In one embodiment, the power adjustment circuit also comprises a first resistor, a first transistor, a first RC circuit, a second resistor, a second transistor, and the second RC circuit. The drain terminal of the first transistor is connected to the first resistor and the source terminal of the first transistor is connected to ground. The first RC circuit is connected to the gate terminal of the first transistor and is used to control, as a switch, the on and off state of the first transistor according to the first flag signal.

In one embodiment, the current amplification circuit also comprises a first op-amp, a third resistor, a fourth resistor, and a first capacitor. The non-inverting input of the first op-amp is grounded and the inverting input of the op-amp is connected to the power adjustment circuit. One terminal of the third resistor is connected to the inverting input of the first op-amp and the other terminal of the third resistor is grounded. One end of the fourth resistor is connected to the inverting input of the first op-amp and the other end of the fourth resistor is connected to the output the first op-amp. The first capacitor is arranged in parallel with the fourth resistor.

In one embodiment, the voltage adjustment module comprises a voltage adjustment circuit and a voltage adjustment circuit. The voltage adjustment circuit is used to receive the voltage adjustment signal of all current flow circuits and to output voltage adjustment signals, and the voltage adjustment circuit adjusts the output voltage of the corresponding power supply according to the voltage adjustment signal to adjust the output current of the power supply.

In one embodiment, the voltage adjustment circuit comprises a second op-amp. The inverting input of the second op-amp receives the voltage adjustment signal of the corresponding current flow circuit, the positive phase input receives a maximum voltage signal, and the output voltage adjustment signal at the output end.

In one embodiment, the maximum value of voltage adjustment signals generated by all current flow circuits may be determined through a diode voltage drop.

The invention provides a method of controlling multiple power supplies in parallel, comprising: detecting the PSE type indication signal sent by a network power supply interface, wherein the PSE type indication signal contains the power supply rating output power information, and aligning the ratio of output current between all power supplies with the rated output power ratio between all power supplies.

The power supply control system of this invention receives the PSE type indication signal sent by the power supply interface through the current amplification module, thus judging the rated output power information of the corresponding power supply, and the voltage adjustment module is based on the basis of the voltage adjustment signal for all the power supply adjusts the voltage adjustment module corresponding to the power output voltage, so as to adjust the output current of the power supply, and make the ratio of output current between all after adjustment and the rated output power ratio between all the power supplies tend to be consistent with the rated output power ratio of all power supplies, so that each power supply can provide the output power in line with their maximum rated power.

### BRIEF DESCRIPTION OF THE DRAWINGS

Other objects and advantages of the present invention will become apparent to those skilled in the art upon reading the following detailed description and upon reference to the drawings in which:

FIG. 1 illustrates an example circuit architecture of a power supply control system according to a first embodiment.

FIG. 2 illustrates an example circuit architecture of the current amplification module according to a second embodiment.

FIG. 3 illustrates an example circuit architecture of the power adjustment circuit according to a third embodiment.

FIG. 4 illustrates an example circuit architecture of the current amplification circuit according to a fourth embodiment.

FIG. 5 illustrates an example circuit architecture of the voltage adjustment module according to a fifth embodiment.

FIG. 6 is a flow chart of a power supply control method according to an embodiment.

### DETAILED DESCRIPTION OF THE INVENTION

It should be understood that while this invention has been described in connection with particular examples thereof, no limitation is intended thereby since obvious modifications will become apparent to those skilled in the art after having the benefit of studying this disclosure.

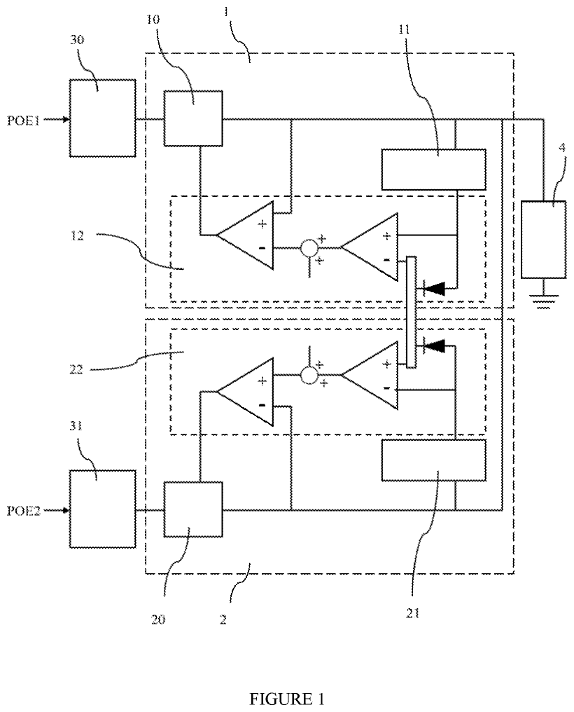

FIG. 1 provides an example of a circuit architecture of the power supply control system according to a first embodiment. As shown in the figure, the power supply control system of this invention comprises a current flow circuit 1 and a current flow circuit 2. Current flow circuits 1 and 2, respectively, are connected through power supply interfaces 30 and 31 to separate power supplies POE1 and POE2. Current flow circuits 1 and 2 are connected to each other and both are also connected to the same load 4. Current flow circuit 1 comprises power adjustment module 10, current amplification module 11, and voltage adjustment module 12. Current flow circuit 2 comprises power adjustment module 20, current amplification module 21, and voltage adjustment module 22.

It should be noted that although FIG. 1 shows two current average flow circuits. this is only an example and not intended to limit the invention. Other embodiments may have three or more current flow circuits connected to additional power supplies.

The following is to the current average flow circuit 1 to explain the mode of operation, power adjustment module 10 and network power supply interface 30 connection, to adjust the power supplied by the power POE1 load 4 power. The current amplification module 11 is connected to the network power supply interface 30 through the power adjustment module 10, which is used to receive the PSE type indication signal sent by the network power supply interface 30, the PSE type indication signal contains the rated output power information of the power POE1, and the current amplification module 11 transmits the voltage adjustment signal according to the PSE type indication signal. Voltage adjustment module 12 is used to receive all current flow circuit 1, 2 voltage adjustment signal, in other words, voltage adjustment module 12 at the same time receives the voltage adjustment signal from the current amplification module 11, 21, and according to the voltage adjustment signal to adjust the voltage adjustment module 12 corresponding to the power supply POE1 output voltage, This adjusts the output current of the power supply POE1.

The current flow circuit 2 also performs the above actions at the same time, namely that voltage adjustment module 22 based on the voltage from the current amplification module 11, 21 to judge the signal adjustment voltage adjustment module 22 corresponding to the power POE2 output voltage.

The adjusted ratio of output current between all power supplies POE1 and POE2 is consistent with the rated output power ratio between all power supplies POE1 and POE2. For example, if power supply POE1 is rated at 71 W of output power and power supply POE2 is rated at 25.5 W of output power, the output current ratio between the adjusted power supply POE1 and POE2 will be about 2.82:1, so that when power supply POE2 outputs 25.5 W of power, the power supply POE1 outputs 71 W power, rather than being limited to the same 25.5 W as power supply POE2. The overall output power between POE1 and POE2 is the sum of the output power of POE1 (71 W) and POE2 (25.5 W), that is, 96.5 W, so the power supply control system of the present invention can provide greater overall output power than conventional parallel power supply arrangements, without requiring larger individual power supplies or much additional control circuitry to be used.

In one embodiment, power adjustment modules 10 and 20 can also be used to compensate for line loss, or voltage drops across the network transmission line.

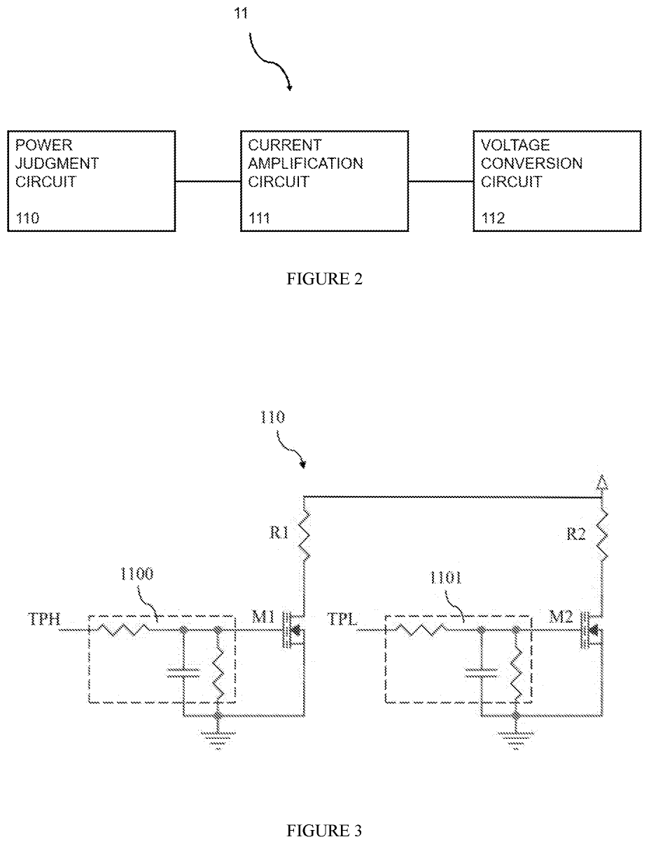

FIG. 2 illustrates an example circuit architecture of the current amplification module according to a second embodiment. In this embodiment, the current amplification module 11 comprises a power adjustment circuit 110, a current amplification circuit 111, and a voltage conversion circuit 112. Power adjustment circuit 110 is used to judge the rated output power of the power supply POE1 based on the PSE type indication signal and to send the first adjustment signal. Current amplification circuit 111 is used to amplify the output current of the power supply POE1 based on the first adjustment signal. Voltage conversion circuit 112 is used to convert the amplified output current into a voltage adjustment signal.

The PSE type indication signal may comprise the first flag signal TPH and the second flag signal TPL which together represent the rated output power information of the power supply. For example, the rated output power of a power supply in a PSE may be 25.5 W, 51 W, or 71 W, which may indicated by the high and low values of TPH and TPL as shown below:

TPH=high and TPL=low: 25.5 W output power
TPH=low and TPL=high: 51 W output power
TPH=low and TPL=low: 71 W output power

FIG. 3 illustrates an example circuit architecture of the power adjustment circuit according to a third embodiment. In this embodiment, the power adjustment circuit 110 further comprises a first resistor R1, a first transistor M1, a first RC circuit 1100, a second resistor R2, a transistor M2, and a second RC circuit 1101. The emitter terminal of the first transistor M1 is connected to the first resistor R1 and the source terminal is grounded. The first RC circuit 1100 is connected to the gate terminal of the first transistor M1 and is used to control the first transistor according to the TPH signal.

The second resistor R2 is connected in parallel with the first resistor R1, wherein one end of the second resistor R2 is connected to one end of the first resistor R1 and the current amplification circuit 111. The emitter terminal second of the second transistor M2 is connected to the other end of second resistor R2 and the source terminal is grounded. The second RC circuit 1101 is connected to the gate terminal of the second transistor M2 and is used to control the second transistor according to the TPL signal.

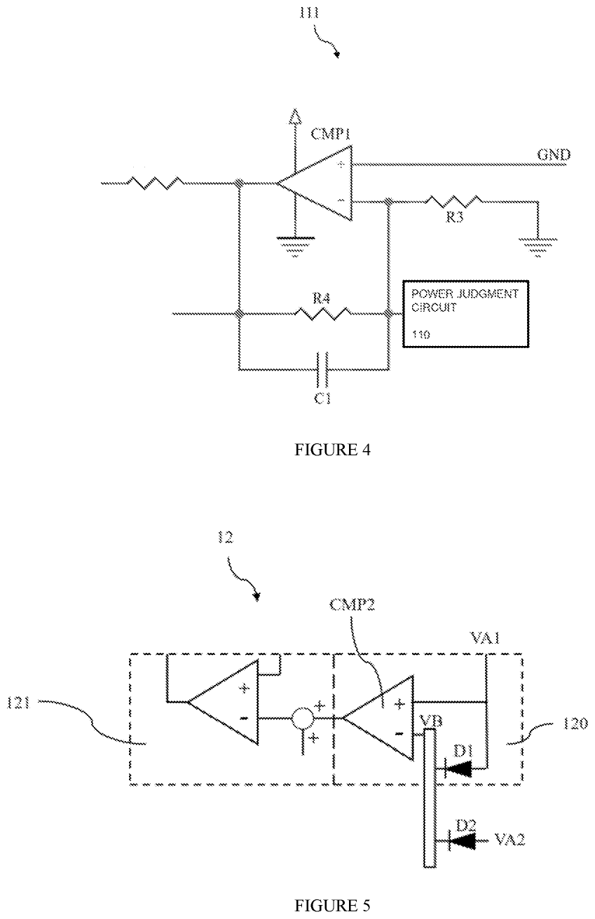

FIG. 4 illustrates an example circuit architecture of the current amplification circuit according to a fourth embodiment. In one embodiment, the current amplification circuit 111 further comprises a first op-amp CMP1, a third resistor R3, a fourth resistor R4, and a first capacitor C1. The first op-amp CMP1 is grounded at the non-inverting input, and the inverting input is connected to the power adjustment circuit 110, specifically with one end connected to the first resistor R1 and the second resistor R2. One end of the third resistor R3 end is connected to the inverting input of the first op-amp CMP1 and the other end is grounded. The fourth resistor R4 is connected to the inverting input and the output of the first op-amp CMP1. The first capacitor C1 is connected in parallel with the fourth resistor C4.

With reference to FIG. 3 and FIG. 4 at the same time, the following describes the operations of the power adjustment circuit 110 and current amplification circuit 111. Since the first resistor R1, the second resistor R2 and the third resistor R3 are paralleled and connected to the fourth resistor R4, a feedback circuit is formed to control the current amplification ratio of the first op-amp CMP1. The first flag signal TPH and the second flag signal TPL control the first transistor M1 and the second transistor M2, respectively, to turn them on and off, thus determining whether the third resistor R3 is paralleled with the first resistor R1, the second resistor R2, and further combined with the fourth resistor R4 to form a feedback circuit to control the first op-amp CMP1 current amplification ratio. Thus for example, if the resistors have the values R1=5.49 K, R2=24.3 K, R3=10 K, and R4=402K, then when TPH is high and TPL is low potential, the current amplification ratio of the first op-amp CMP1 is 113.55 (402K/(10K/5.49K). The possible current amplification ratios of CMP1 based on combinations of the values of TPH and TPL are set forth below:

TPH=high and TPL=high: 130 current amplification ratio (402 K/(10 K/24.3 K/5.49 K))
TPH=high and TPL=low: 113.55 current amplification ratio (402 K/(10 K/5.49 K))
TPH=low and TPL=high: 56.74 current amplification ratio (402 K/(10 K/24.3 K))
TPH=low and TPL=low: 40.2 current amplification ratio (402 K/10 K)

FIG. 5 illustrates an example circuit architecture of the voltage adjustment module according to a fifth embodiment. In this embodiment, voltage adjustment module 12 comprises a voltage adjustment circuit 120 and a voltage adjustment circuit 121. Voltage adjustment circuit 120 is used to receive voltage adjustment signals for current flow circuits 1 and 2, and outputs voltage adjustment signals. Voltage adjustment circuit 121 adjusts the output voltage of the corresponding power supply POE1 based on the voltage adjustment signals.

Voltage adjustment circuit 120 comprises a second op-amp CMP2. The non-inverting input of the second op-amp CMP2 receives the voltage adjustment signal VA1 from current flow circuit 1 and the inverting input of CMP2 receives VB, which is the maximum voltage between VA1 and the voltage adjustment signal VA2 from current flow circuit 2.

The maximum voltage signal VB is determined by inputting the voltage adjustment signal VA1 from current flow circuit 1 and voltage adjustment signal VA2 from current flow circuit 2 through diodes D1 and D2, respectively, which are connected in parallel. Thus, for example, if the voltage adjustment signal VA1 is higher than the voltage adjustment signal VA2, and the specifications of diodes D1 and D2 are generally the same, then the maximum voltage signal VB will be about equal to the voltage adjustment signal VA1.

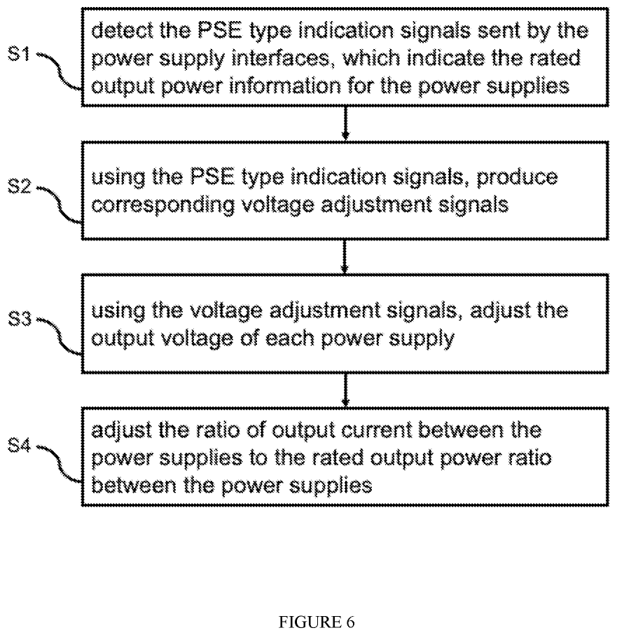

FIG. 6 is a flow chart of a power supply control method according to an embodiment. At step S1, detect the PSE type indication signals sent by the power supply interfaces, which indicate the rated output power information for the power supplies. At step S2, using the PSE type indication signals, produce corresponding voltage adjustment signals. At step S3, using the voltage adjustment signals, adjust the output voltage of each power supply. At step S4, adjust the ratio of output current between the power supplies to the rated output power ratio between the power supplies. Steps S1 to S4 can be implemented by the above-mentioned power supply system.

In summary, the power supply control system of the present invention receives the PSE type indication signal sent by the power supply interface through the current amplification module, thus judging the rated output power information of the corresponding power supply, and the voltage adjustment module adjusts the voltage adjustment voltage of the corresponding voltage signal according to the corresponding power supply, In order to adjust the output current of the power supply, and make the adjusted ratio of output current between all power supplies and all power supply ratio of the rated output power ratio tend to be consistent, so that, in operation, each power supply can actually output power in line with their maximum rated output power.

The above-described embodiments are intended to be exemplary embodiments illustrating the principles of the present invention and are not intended to be limiting. Each embodiment may be used individually or in combination with one or more of the other embodiments described herein. Modifications and variations of the above-described embodiments can be made by those skilled in the art without departing from the spirit and scope of the invention.

We claim:

1. A power supply control system comprising:
a first current flow circuit connected to a first independent power supply through a first power supply interface;
a second current flow circuit connected to a second independent power supply through a second power supply interface;
wherein the first current flow circuit is connected to the second current flow circuit, and the first current flow circuit and second current flow circuit are connected to a load; and
wherein each current flow circuit comprises:
a power adjustment module connected to the corresponding power supply interface to adjust the output power supplied to the load by the corresponding power supply;
a current amplification module, through which the corresponding power adjustment module is connected to the corresponding power supply interface, to receive the PSE type indication signal sent by the power supply interface, wherein the PSE type indication signal indicates the rated output power information of the power supply, and to transmits a voltage adjustment signal according to the PSE type indication signal;
a voltage adjustment module to receive the voltage adjustment signal of the first and second current flow circuits and to adjust the output current of the power supply; and
where the adjusted ratio of the output current between the first and second independent power supplies is consistent with the rated output power ratio between the first and second independent power supplies.

2. The power supply control system of claim 1, wherein the power adjustment module compensates for line loss.

3. The power supply control system of claim 1, wherein the current amplification module further comprises:
a power adjustment circuit to judge the rated output power of the power supply according to the PSE type indication signal, and to send the first judgment signal;
a current amplification circuit to amplify the output current of the power supply based on the first determination of the signal; and
a voltage conversion circuit that converts the amplified output current to the voltage to determine the signal.

4. The power supply control system of claim 3, wherein the PSE type indication signal comprises a first flag signal and a second flag signal indicating the power supply's rated output power information.

5. The power supply control system of claim 4, wherein the power adjustment circuit further comprises:
a first resistor;
a first transistor, wherein the emitter terminal of the first transistor is connected to the first resistor and the source terminal of the first transistor is connected to ground;
a first RC circuit connected to the gate terminal of the first transistor to control the first transistor in accordance with the first flag signal;
a second resistor connected in parallel with the first resistor;
a second transistor, wherein the emitter terminal is connected to the second resistor and the source terminal of the second transistor is connected to ground; and
a second RC circuit connected to the gate terminal of the second transistor to control the second transistor in accordance with the second flag signal.

6. The power supply control system of claim 3, wherein the current amplification circuit further comprises:
a first op-amp, wherein the non-inverting input of the first op-amp is connected to ground and the inverting input of the first op-amp is connected to the power adjustment circuit;
a third resistor, wherein one end of the third resistor is connected to the inverting input of the first op-amp and the other end of the third resistor is connected to ground;
a fourth resistor, wherein one end of the fourth resistor is connected to the inverting input of the first op-amp and the other end of the fourth resistor is connected to the output of the first op-amp;
a first capacitor connected in parallel with the fourth resistor.

7. The power supply control system of claim 1, wherein the voltage adjustment module further comprises:
a voltage adjustment circuit to receive the voltage adjustment signal from the first and second current flow circuits and to output a voltage adjustment signal; wherein
the voltage adjustment circuit adjusts the output voltage of the corresponding power supply based on the voltage adjustment signal, thereby adjusting the output current of the power supply.

8. The power supply control system of claim 7, wherein the voltage adjustment circuit further comprises:
a second op-amp, wherein the inverting input of the second op-amp receives the voltage adjustment signal of the corresponding current flow circuit, and the non-inverting input of the second op-amp receives a maximum voltage adjustment signal.

9. The power supply control system of claim 8, wherein the maximum voltage signal is determined by a diode voltage drop connected to the first and second current flow circuits.

10. A method of controlling a power supply system comprising a first power supply and a second power supply, comprising the steps of:
detecting a first PSE type indication signal from the first power supply and a second PSE type indication signal from the second power supply, wherein each PSE type indication signal indicates the rated output power of the corresponding power supply,
using the first and second PSE type indication signals, generating a first voltage adjustment signal and a second voltage adjustment signals,
using the first and second voltage adjustment signals, adjust the output voltage of each power supply, and
adjusting the ratio of output current between the first and second power supplies to the ratio of the rated output power between the first and second power supplies.
